(19) United States
(12) Patent Application Publication
(10) Pub. No.: US 2007/0146575 A1
(43) Pub. Date: Jun. 28, 2007

(54) Active matrix display device and method of producing the same

(75) Inventors: Joost P.A. Vogels, Leende (NL); Dirk J. Broer, Geldrop (NL); Hjalmar E.A. Huitema, Veldhoven (NL); Stephen I. Klink, Breda (NL); Hendrik De Koning, Well (NL); Roel Penterman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/579,615

(22) PCT Filed: Nov. 17, 2004
(86) PCT No.: PCT/IB04/52460

§ 371 Date: May 17, 2006

(30) Foreign Application Priority Data
Nov. 22, 2003 (GB) 0327215.0

(51) Int. Cl. G02F 1/1333

(52) U.S. Cl. 349/88

(57) ABSTRACT

A method is provided of producing an active matrix display device having an optical layer comprising a mixture of an electro-optical material and a polymer precursor. An upper layer of the active plate is processed in dependence on a difference between the transmission or reflection characteristics of the row and column conductors and of the pixel electrodes, thereby to process the upper layer in dependence on the row and column pattern or the pixel electrode pattern. The optical layer is then exposed from above the substrate to a stimulus for polymerizing the polymer precursor into a discrete polymer surface layer, thereby enclosing the electro-optical material between the polymerized material and the active plate to define display pixels. Enclosed bodies of electro-optical material defining display pixels are defined in a pattern defined by the processing of the upper layer. This method uses the existing row and column pattern or pixel electrode pattern to define in a self-aligned manner the partitions between liquid crystal cell pockets.

The present invention relates to active matrix display devices and a method of producing such devices. In particular, the invention relates to a display having a stratified light modulation layer.

A number of different types of flat display device are available, such as electrophoretic displays, like e-ink devices, and liquid crystal displays (LCDs). LCDs have become increasingly popular over recent years. LCDs can be found in a wide range of products, from handheld electronic devices like personal digital assistants and mobile phones to computer monitors and television sets.

Currently, significant efforts are being made to enable the dimensions of these display devices to be increased. The traditional production method for LCDs is to deposit a liquid crystal material between two glass or polymer plates. Increasing the size of the substrate panels makes them difficult to handle. In addition, large substrate panels require large and heavy machinery, which makes the production process costly.

European patent application EP 1065553 A1 discloses an alternative method for producing a liquid crystal display. A layer of a mixture of a polymer precursor and a liquid crystal (LC) material is deposited on a transparent substrate carrying an orientation layer, after which the mixture is exposed to UV light in a photolithographic step. In this step, the polymer precursor is polymerized to form sidewalls between the desired pixels of the LCD. Subsequently, the rest of the mixture is exposed to UV light. This triggers a phase separation in which the polymer precursor is polymerized to form a continuous top layer on top of the polymer sidewalls, and in which the LC material is trapped between the polymer top layer, the polymer sidewalls and the substrate, thus forming a plurality of pixels on the substrate. The polymer top layer serves as a second substrate.

This process allows the layer of a mixture of a polymer precursor and a liquid crystal (LC) to be applied by a coating process, which simplifies and reduces the cost of the fabrication process. This process also enables the optical stack to be thinner than in conventional LCDs. However, a drawback of this method is that several photolithography steps are required to form the separate LC pixels, and the development and production of masks is costly. These photolithography steps are required in particular to define the polymerized side walls of each pixel. Furthermore, this process requires a number of different UV exposure steps, of different wavelengths and intensities, in order to define side walls which penetrate the full depth of the mixture, and a top shallow surface layer of polymerized material.

The applicant has proposed (but not published at the date of filing this application) an alternative process in which a single exposure step is required. In this process, a stamping process is used to selectively deposit a chemically functionalized species over the substrate. This gives parts of the substrate a high affinity for the polymerizable material of the mixture (in particular a high affinity to partially polymerized material). During a single UV irradiation step, the high affinity regions result in the polymerization concentrating at those regions of the mixture. When the mixture is partially polymerized, non-polymerizable liquid tends to concentrate at the spaces between the high affinity regions, thereby defining the liquid crystal cells, whereas the polymerized parts of the mixture concentrate at the top surface (where the irradiation intensity is greatest) and at the high affinity regions, thereby defining side walls.

This process simplifies the UV irradiation process, but still requires accurate alignment of the stamp used to deposit the functionalized species.

According to the present invention, there is provided a method of producing an active matrix display device having an optical layer comprising a mixture of an electro-optical material and a polymer precursor, the method comprising:

producing an active plate comprising a substrate carrying:
an array of pixel circuits each having a pixel electrode:
a plurality of row conductors associated with rows of pixels; and
a plurality of column conductors associated with columns of pixels;

photo-processing an upper layer of the active plate in dependence on a difference between the transmission or reflection characteristics of the row and column conductors and of the pixel electrodes, thereby to process the upper layer in dependence on the row and column pattern or the pixel electrode pattern;

exposing the optical layer from above the substrate to a stimulus for polymerizing the polymer precursor into a discrete polymer surface layer, thereby enclosing the electro-optical material between the polymerized material and the active plate to define display pixels, and wherein enclosed bodies of electro-optical material defining display pixels are defined in a pattern defined by the processing of the upper layer.

This method uses the existing row and column pattern or pixel electrode pattern to define in a self-aligned manner the partitions between liquid crystal cell pockets. This avoids the need for a mask exposure step, including the accurate alignment of the mask with the substrate, prior to the flood exposure of the optical layer.

Preferably, the photo-processing comprises using irradiation through the substrate, and through the either the row and column conductors or through the pixel electrodes.

The optical layer mixture of an electro-optical material and a polymer precursor may be provided over the active plate after the processing of the upper layer. For example, the upper layer may define raised side walls, and the mixture can be filled into the spaces between the side walls. The upper layer may comprise a photo-resist layer deposited over the substrate.

The photo-resist layer will be a positive photo-resist if the row and column conductors are not transparent to the irradiation used in the processing and the pixel electrodes are transparent to the irradiation used in the processing. The processing then comprises removing the exposed photo-resist to leave regions of photo-resist over the row and column electrode pattern. These regions thus define the side walls.

The photo-resist layer will be a negative photo-resist if the row and column conductors are transparent to the irradiation used in the processing and the pixel electrodes are not transparent to the irradiation used in the processing. In this case, the processing comprises removing the non-exposed photo-resist to leave regions of photo-resist outside the pixel electrode pattern. Thus, the space left between the side walls corresponds to the pixel electrode pattern.

As mentioned above, the optical layer mixture is provided in the spaces between the remaining photo-resist regions. However, it can also be provided over the remaining photo-resist regions, so that a continuous top layer is provided which forms a continuous polymer surface layer.

The pixel cells are: thus enclosed by photo-resist layer side walls, the active plate, and the polymer surface layer.

Instead of providing the optical layer mixture over the active plate after the processing of the upper layer, the optical layer mixture of an electro-optical material and a polymer precursor may be provided over the active plate before the processing, and the upper layer can itself comprise the optical layer mixture.

Thus, the row and column pattern or the pixel electrode pattern can be used for selective irradiation of the optical layer mixture. For example, the row and column conductors can be transparent to the irradiation used in the processing and the pixel electrodes can be opaque to the irradiation used in the processing. The processing thereby forms polymerized side walls over the row and column conductor pattern.

A liquid crystal alignment layer can be provided over the active plate.

In one example, a photosensitive alignment layer is provided over the active plate, and when irradiating through the substrate, regions of the photosensitive alignment layer are activated. The light used in this irradiation step may be linearly polarized UV light.

The invention also provides an active matrix display device having an optical layer comprising a mixture of an electro-optical material and a polymer precursor, comprising:

an active plate comprising:
a substrate carrying an array of pixel circuits, each having a pixel electrode;
a plurality of row conductors associated with rows of pixels; and
a plurality of column conductors associated with columns of pixels; and

an array of display pixels comprising electro-optical material enclosed between side walls, a polymerized surface layer of the mixture and the active plate, and wherein the side walls are aligned over the row and column conductor pattern.

The side walls may be formed from photo-resist or they may be formed from the polymer precursor in the mixture.

The invention also provides an active matrix display device having an optical layer comprising a mixture of an electro-optical material and a polymer precursor, comprising:

an active plate comprising:
a substrate carrying an array of pixel circuits, each having a pixel electrode;
a plurality of row conductors associated with rows of pixels; and
a plurality of column conductors associated with columns of pixels; and

an array of display pixels comprising electro-optical material enclosed between side walls, a polymerized surface layer of the mixture and the active plate, and wherein the side walls are aligned with the spaces between the pixel electrode pattern.

Examples of the invention will now be described in detail with reference to the accompanying drawings, in which:

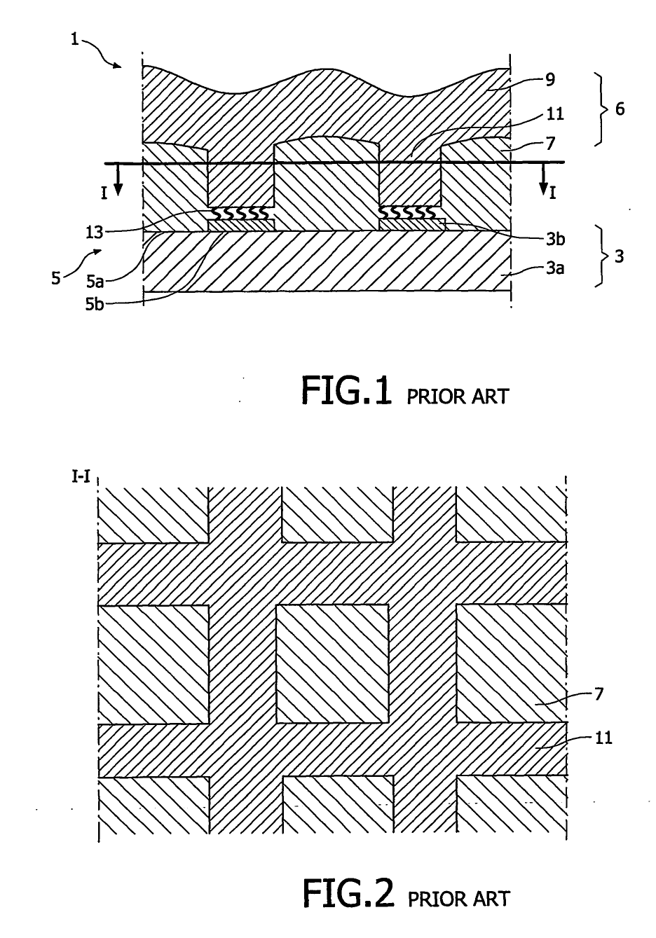

FIG. 1 is used to explain one LCD manufacturing process proposed by the applicant, but not forming part of the invention;

FIG. 2 shows one pixel of the FIG. 1 display in plan view;

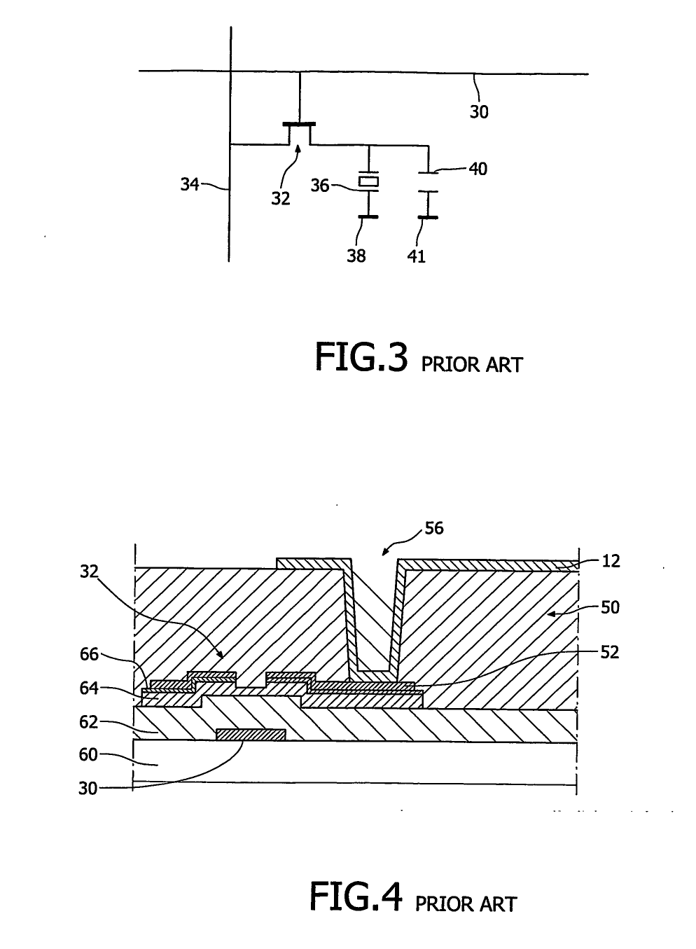

FIG. 3 shows the known pixel circuitry for an active matrix LCD pixel;

FIG. 4 shows the TFT of the pixel circuit of FIG. 3 in cross section;

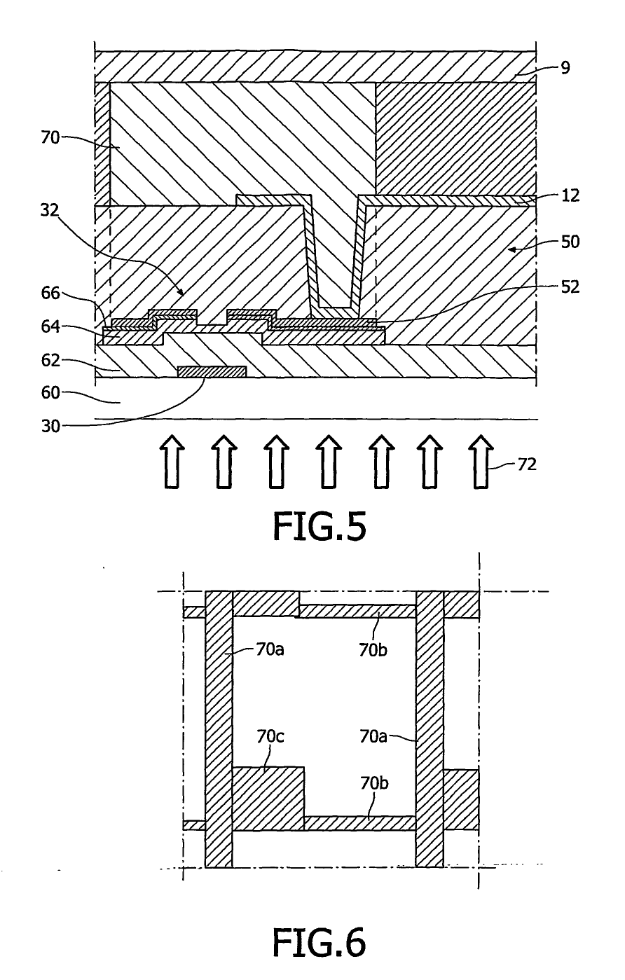

FIG. 5 shows a first pixel arrangement of the invention using a first processing technique;

FIG. 6 shows in plan view the pattern of the row and column conductor metal layer for the pixel arrangement of FIG. 5;

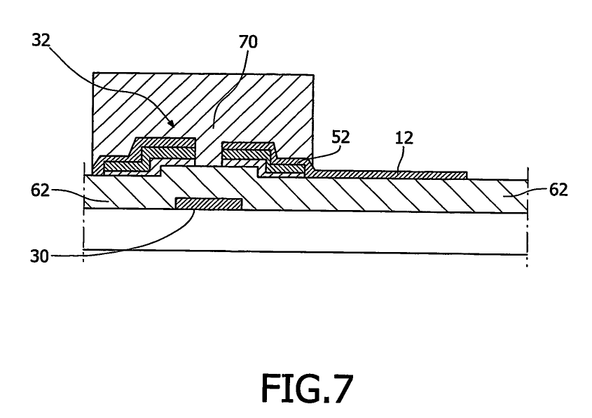

FIG. 7 shows second pixel arrangement of the invention using a second processing technique; and

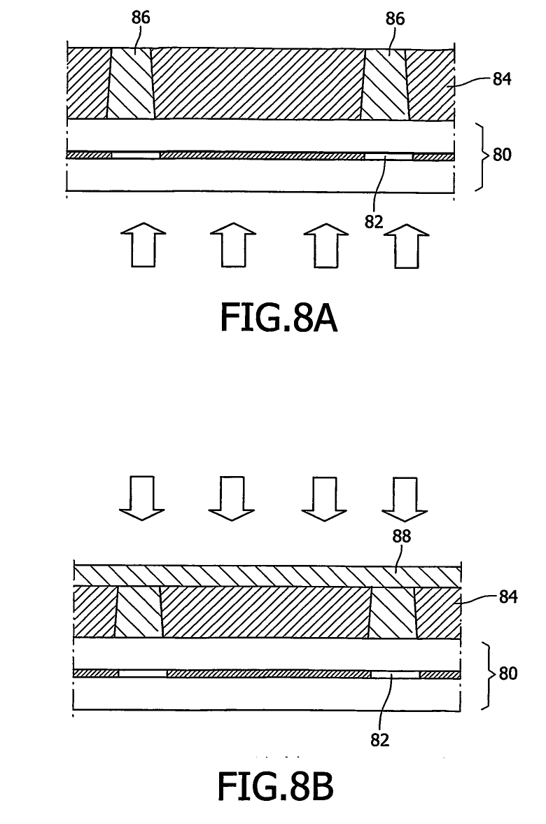

FIGS. 8A and 8B is used to explain a third processing technique of the invention.

FIG. 1 shows in cross section a display device 1 which has been proposed by the applicant, but has not yet been published. The display uses a polymeric stratified-phase-separated composite 6. This comprises a liquid layer 7 which functions in the same way as a conventional liquid crystal layer, and portions 9, 11 of polymerized material. These polymerized material portions provide a covering layer 9 as well as side walls 11, which extend down to the underlying substrate 3. These side walls 11 and the top layer 9 together define encapsulated areas within which portions of liquid crystal material 7 are trapped, and these define individual display pixels.

The substrate comprises a base film 3a and a separate patterned layer 3b. The surface of the patterned layer 3b provides regions 5b of high affinity for the polymerizable material which forms the side walls 11. The regions of the base film 3a which are exposed to the liquid layer 7 provide regions of low affinity 5a.

To render the surface of the patterned layer 3b with a high affinity to the polymerizable material, the surface is functionalized with chemically reactive groups. These groups are capable of reacting with the polymerizable material from which the side walls 11 are obtained to form covalent bonds. These bonds are shown schematically in FIG. 1 by reference 13.

In particular, the high affinity regions 5b are capable of forming covalent bonds with partially polymerized material, and the low affinity regions 5a are not capable of doing so. Covalent bonds are not the only possibility of achieving this. Other possibilities include a substrate surface with polar regions in one area and apolar regions in another area, in combination with either polar or apolar polymerizable material. Similarly, ionic regions and non-ionic regions, or positively charged ionic regions and negatively charged ionic regions in combination with electrically charged polymerizable material may also be used.

The phase-separation of the material 6 is preferably induced by photopolymerization. It is, however, also possible to use solvent or temperature induced phase-separable material.

In the preferred example, the layer of material 6 is subjected to a flood exposure with UV light. The phase-separable material absorbs the UV radiation, and an intensity gradient is set up in the material transverse to the layer thickness. The absorption of radiation by the layer is selected such that a significant amount of radiation is able to reach the substrate surface 5, in particular the high affinity regions 5b.

Initially, the UV irradiation induces polymerization of the material to form partially polymerized material, which is still fully miscible within the liquid of the material. Prior to phase separation, the polymer conversion is substantially constant throughout the layer at each penetration depth, but in directions transverse to the layer, the intensity gradient gives rise to a higher polymer conversion nearer the UV source. This gradient causes migration of unpolymerized material towards the radiation source, and migration of liquid (non-polymerizable) away from the radiation source. Furthermore, at the regions of high affinity 5b, the partially polymerized material reacts with the chemically reactive groups on the surface of the high affinity regions 5b to form the covalent bonds 13, thus adhering the partially polymerized material to the substrate surface and preventing migration of the polymerized material.

As the polymerization proceeds, the polymerized material is no longer miscible within the liquid, and at a certain moment phase-separation occurs. At the end of the process, phase-separation occurs in the regions adjacent the high affinity regions 5b and the liquid becomes encapsulated between the side walls and the top surface layer 9.

Thus, the structure shown in FIG. 1 can be produced with a single UV irradiation step.

The thickness of the layer of polymerized material 9 is typically between 1 and 200 micrometers, or more preferably 10 to 40 micrometers. The liquid film 7 forming the display pixels may have a thickness of around 1 millimeter, although this thickness may be significantly less, for example 200 micrometers or less. A liquid crystal layer preferably has a thickness of 1-10 micrometers.

The use of a stratified-phase-separated composite enables the production of a liquid crystal display which is thin and flexible while maintaining mechanical robustness, and which has reduced production costs.

The polymeric stratified-phase-separated composite is known in the art, as well as the method of producing such materials. By way of example, reference is made to U.S. Pat. No. 6,486,932, WO 02/42832, WO 02/48281, WO 02/48282 and WO 02/48783.

FIG. 2 shows schematically a top view of the display of FIG. 1 along the line I-I. As shown, the side walls 11 form a rectangular grid of walls providing enclosed spaces for the liquid crystal layer 7.

The process described above simplifies the manufacturing process and reduces the manufacturing cost. One disadvantage, however, is that a patterned deposition process is required to form the patterned layer 3b which is processed to form the high affinity regions 5b. This process may be a photolithographic process, or else a stamping process may be used. In either case, accurate alignment is required, in particular so that the layer 3b is aligned correctly with respect to the circuit elements of the individual pixels.

Although not shown in FIG. 1, the substrate 3 will also carry this pixel circuitry and will comprise many more layers than those shown in FIG. 1. The substrate 3 will in practice comprise the active plate of an active matrix display.

The invention modifies the processing of the active plate 3 to enable the encapsulated liquid crystal cells 7 to be formed by a self-aligned process. Either the row and column conductors or the pixel electrodes will be transparent, and this difference is used to process the upper layer in dependence on the row and column pattern or the pixel electrode pattern. Enclosed bodies of electro-optical material defining display pixels are thus defined in a pattern defined by the processing of the upper layer.

Before describing the invention, an example of the active plate for an active matrix liquid crystal display will first be described.

FIG. 3 shows the electrical components which make up the pixel circuit for each pixel. A row conductor 30 is connected to the gate of a TFT 32, and a column electrode 34 is coupled to the source. The liquid crystal material provided over the pixel effectively defines a liquid crystal cell 36 which extends between the drain of the transistor 32 and a common ground plane 38. The ground plane 38 is defined by the passive plate and the other terminal of the LC cell is defined by pixel electrodes 12. A pixel storage capacitor 40 is connected between the drain of the transistor 32 and the row conductor associated with an adjacent row of pixels or else to a separate line 41.

FIG. 4 shows a cross-section through the TFT of one example of known active plate for a transmissive display.

A metal layer is used for the row conductors and the gate electrode 30, and a metal layer 52 is used for the source and drain. A transmissive conductive material is needed for the pixel electrode 12, such as ITO.

The pixel electrode 12 is provided over a passivation layer 50 and contacts the drain 52 of the TFT 32 through a contact hole 56 in the layer 50. The passivation layer is typically 100 nm to 500 nm thick, but can be thicker if required. In an alternative Field Shielded Pixel (FSP) design, a thicker passivation layer is used, for example 1 to 3 micrometers of polyimide. In a FSP design, the pixel electrodes 12 can overlap the row and column conductors 30,34, so that there is no gap between the row and column conductors and the pixel electrodes, which would otherwise need to be shielded. This results in a high aperture pixel.

In more detail, the active plate structure of FIG. 4 comprises a glass substrate 60, a gate metal layer 30 (which forms also the row conductors), and a silicon nitride gate insulator 62. The transistor body is defined by an amorphous silicon layer 64 and an n⁺ amorphous silicon contact layer 66.

A single source-drain metallizabon defines the source and drain 52.

The known method of forming a stratified liquid crystal display of EP 1065553 can be applied to the active plate such as shown in FIG. 4, and the active plate of FIG. 4 can also be used for the process proposed by the applicant as described above with reference to FIGS. 1 and 2.

FIG. 5 shows a first modification to the active plate of FIG. 4 to implement the invention.

In a first example, the invention makes use of the nontransparency of the row and column conductors in the electrode structure of the active plate. As shown in FIG. 5, an additional photo-resist layer 70 is provided over the top of the active plate which has been manufactured in conventional manner as described with reference to FIG. 4. This photo-resist layer 70 is patterned using irradiation 72 from the opposite side of the substrate 60. The row and column conductors, and the drain and source contacts of the transistor act as a mask during this irradiation step. After etching, the patterned photo-resist layer 70 as shown in FIG. 5 results.

FIG. 6 shows the pattern of the photo-resist layer 70 which results from the operation described with reference to FIG. 5. As shown, the pattern has portions 70a corresponding to the column (data) conductors, portions 70b corresponding to the row conductors and portions 70c corresponding to the TFT drain and source.

In this example, the photo-resist 70 is a positive photo-resist, for example a novolac-based photo-resist. The active plate can be covered with this photo-resist by spin coating. When the irradiated parts of the photo-resist are stripped, this reveals the pixel pads, and the remaining photo-resist 70 as shown in FIG. 5 defines side walls.

The height difference created by the remaining photo-resist 70 can be used in a number of ways.

In one arrangement, the photo-resist layer 70 can avoid the need to form the polymer side walls 11 of FIG. 1. Thus, the need for alignment of a mask for forming polymer side walls can be avoided. Instead, the optical mixture can be spray-coated to fill the spaces between the photo-resist portions 70, and preferably also to provide a thin top coat over the top of the structure. The subsequent exposure of the mixture to UV light forms the polymerised surface layer 9 as in the prior art, but the side walls are defined by the photo-resist 70, as shown in FIG. 5. Depending upon the height of the photo-resist layer 70, it may not be necessary to completely fill the spaces between the side walls, so that a top coat covering the entire active plate is not necessary.

In another example, the height differences created by the photo-resist layer 70 can be used to enable a stamping process to be used to selectively deposit a reactive species on the higher parts of the active plate. As in the known process described with reference to FIG. 1, this reactive species can result in the formation of polymer side walls within the optical mixture during UV irradiation without the need for any masking during the irradiation step. The irradiation also forms the surface layer, as described with reference to FIG. 1.

Typically, a thickness of the photo-resist layer of 500 nm will result in the layer forming an upper surface which extends above all other parts of the active plate. The photo-resist layer can be made thicker, for example around 1 micrometer in order to increase further these height differences.

The height difference enables the functionalized material to be deposited without the need of a patterned stamp. This removes the difficult step of exact alignment of a stamp with respect to the pixel pads. In this way, the stratified liquid crystal process can be applied in a self-aligned way without the need of any additional mask step.

For most LC materials, an alignment layer is required. This alignment layer can be applied before depositing the photo-resist layer 70. Of course, it will then need to withstand the stripping process of the photo-resist layer. Alternatively, the alignment layer can be applied after forming the photo-resist walls 70. In this case, the patterned photo-resist will need to withstand the processing steps applied to the alignment layer. For example, in the case of a polyimide alignment layer, high temperature baking is employed, and various solvents are also used, such as N-methylpyrrolidone. In order to improve the resistance of the photo-resist side walls to these processes, a post-bake of the photo-resist at elevated temperatures may be required.

The alignment layer is currently typically deposited by spin coating. If the height differences are not too large, spin coating can still be employed even if the alignment layer is to be provided over the photo-resist layer 70. However, so-called flexoprinting may be more appropriate, as this is less sensitive to height differences. The alignment layer is typically polyimide, and is not shown in the drawings. However, this will cover the exposed upper surface of the active plate. The height differences can also cause problems during rubbing of the polyimide. A contactless alignment method, such as ion beam alignment or photoalignment can then be used.

When a functionalized species is to be applied by a stamping process, a stiff rubber stamp with no height differences can be used. This may comprise a rubber stamp glued on to a stiff substrate for example an aluminium foil. Alternatively, a more densely cross-linked rubber may be used so that the stamp is much stiffer than the PDMS material that is currently used.

In the example above, the photo-resist layer 70 is provided over the completed active plate of FIG. 4.

In an alternative embodiment, shown in FIG. 7, the photo-resist layer 70 can replace the passivation layer 50. As shown in FIG. 7, the pixel electrode 12 is provided over the gate dielectric layer 62. The photo-resist layer 70 then operates in the same way as described with reference to FIG. 5, and can either provide the side walls or can provide a support for a reactive species in order to provide polymer side walls as explained with reference to FIG. 1.

The examples above make use of the difference in transmission properties between the row and column conductors and the ITO pixel electrodes. There is also a large difference in reflection properties of these materials. Thus, the processing of the photo-resist can be carried out using illumination from above the substrate rather than through the substrate. In such a process, a highly non-linear positive photo-resist can be used which builds up contrast at intensities equal to the sum of incoming and reflected light. The reflection properties of the row and column conductors thus result in contrast within the photo-resist being formed at the location of the row and column conductors and not at the location of the pixel electrode. A negative photo-resist can also be used in this process, for example based on epoxides or polyfunctional acrylates.

In reflective LCD display designs, the row and column conductors are designed to be transparent, and the pixel electrode is non-transparent.

In this case, the mixture of an electro-optical material and a polymer precursor can again be used to form polymer side walls, but in accordance with the invention this can be carried out using the row and column electrode pattern.

FIG. 8A shows schematically the active plate 80 in which essentially only the row and column conductors 82 are transparent. The mixture of the electro-optic material and the polymer precursor is provided as layer 84 over the active plate 80.

In the first illumination step of FIG. 8A, irradiation through the substrate results in a horizontal phase separation, creating polymer walls above the row and column conductors and above the transistor. These polymer walls are shown as 86 in FIG. 8A. In the second illumination step of FIG. 8B, irradiation from above the substrate induces vertical phase separation providing the polymer surface layer 88.

As mentioned above, an alignment layer will typically be required. It is possible to make use of a photo alignment layer, for example polyvinyl cinnamate, or a coumarine type of layer. These photo alignment layers operate by a cyclo-addition reaction of the cinnamate or coumarine double bonds.

When exposed with polarized UV light only the chromophores parallel to the electrical field vector of the UV light will undergo reaction and it is well known that in this case LC molecules will become aligned. The exposure through the back of the substrate is such that the cyclo-addition reaction will take place only in the area where the alignment layer is irradiated, i.e. at the position of the pixel pads. This is also the place where LC alignment is desired. However around the pixel pads, where the light was blocked, the double bonds of the photoalignment layer are still unaffected. When the stratified mixture is applied on this layer with alternating areas without double bonds (the areas where LC alignment is enforced) and with double bonds, automatically polymer protrusions are formed.

This provides another method of creating polymerized side walls without requiring masking of the irradiation step.

In the examples above, the height differences created by the photo-resist layer are preferably used to form the side walls needed for the stratified process. The array of photo-resist walls may be as high as 10 μm. A wall height of around 5 micrometers or more will typically be sufficient for the processing steps that are needed to form the polymer walls during stratified LC processing to be omitted. In this way, the stratified LC process can be applied in a self-aligned way without the need of an additional mask step. This avoids the need for the stamping step as no polymerized side walls are required.

In addition, the photo resist can be modified in such a way that it reacts with the polymer of the stratified layer itself. In this way, the photo resist layer can have two functions. It defines the shapes for the display pixel cells, and in addition it contains the reactive groups that allow the polymer layer formed during the stratification process to bind b the photo resist layer. In this way the stamping step can be eliminated whilst still forming polymerized side walls on top of the photo-resist side walls.

This process can be applied to amorphous silicon or poly-silicon processes.

The invention is also applicable to an active matrix display using polymer electronics. The preferred arrangement of layers for the active plate using polymer electronics is based on gold electrodes, an organic gate dielectric layer (a photo resist) and a “HPR” passivation layer (also a photo resist).

As mentioned above, the LC and precursor mixture is already known in the art. By way of example, a suitable composition is as follows:
50 weight percent (wt %) of a liquid crystal mixture, for instance the mixture E7, which is marketed by Merck;
44.5 weight percent (wt %) of photo-polymerizable isobornylmethacrylate (supplied by Sartomer); and
5 weight percent (wt %) of a stilbene dimethacrylate dye:

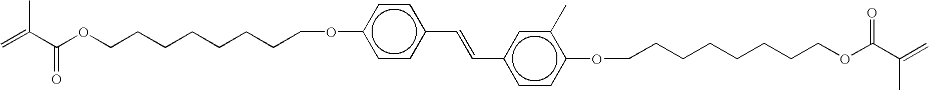

The synthesis of this has been disclosed in PCT patent application WO 02/42382 and which is hereby incorporated by reference, the two acrylates being the polymer precursor; and
0.5 weight percent (wt %) of benzildimethylketal, which is marketed by Ciba-Geigy under the trade name Irgacure 651.

The UV exposure of this material to provide the polymerization may for example involve exposing the layer to UV light with a light intensity of around 0.1 mW/cm² for 30 minutes at 40° C.

The inclusion of a compound having a chromophore strongly absorbing in the UV region of the electromagnetic spectrum, i.e., the stilbene dimethacrylate dye in the example above, causes the desired gradient in the UV intensity through the layer. This effect may be amplified by the UV absorptions of the other components of the liquid, like the other components of the polymer precursors and the electro-optical materials. Consequently, the polymerization reaction predominantly takes place at the surface facing the UV source.

When other stimuli for triggering the polymerization reaction are used, care has to be taken that the polymerization reaction predominantly takes place at the surface.

Where a high affinity layer is required, this may be deposited with a stamp simultaneously contacting the whole raised photo-resist parts of the surface of the active plate, or with a stamp that is rolled over the surface of the carrier.

The electronic device 1 of the present invention has particular advantages when the carrier 10 is a flexible carrier.

The invention can be applied to many different display pixel configurations. For example, an IPS (In-Plane Switching) active plate has the drain is structured into a comb-shape. The opposite (common) electrode also has a comb shape and is connected to the gate line. The use of metal lines instead of ITO for transmissive IPS displays is possible, as this does not significantly reduce the aperture, because the LC material above the electrodes does not switch in the IPS mode.

It should be noted that the above-mentioned embodiments illustrate rather than limit the invention, and that those skilled in the art will be able to design many alternative embodiments without departing from the scope of the appended claims.

1. A method of producing an active matrix display device having an optical layer comprising a mixture of an electro-optical material and a polymer precursor, the method comprising:
producing an active plate comprising a substrate (60) carrying:
an array of pixel circuits each having a pixel electrode (12):
a plurality of row conductors (30) associated with rows of pixels; and
a plurality of column conductors (34) associated with columns of pixels;
photo-processing an upper layer (70) of the active plate in dependence on a difference between the transmission or reflection characteristics of the row and column conductors and of the pixel electrodes, thereby to process the upper layer (70) in dependence on the row and column pattern or the pixel electrode pattern;
exposing the optical layer from above the substrate to a stimulus for polymerizing the polymer precursor into a discrete polymer surface layer (9), thereby enclosing the electro-optical material between the polymerized material and the active plate to define display pixels, and wherein enclosed bodies of electro-optical material defining display pixels are defined in a pattern defined by the processing of the upper layer (70).

2. A method as claimed in claim 1, wherein photo-processing an upper layer (70) of the active plate comprises using irradiation (72) through the substrate, and through the either the row and column conductors or through the pixel electrodes.

3. A method as claimed in claim 1, further comprising providing the optical layer mixture of an electro-optical material and a polymer precursor over the active plate after the processing of the upper layer (70).

4. A method as claimed in claim 3, wherein the upper layer (70) comprises a photo-resist layer deposited over the substrate.

5. A method as claimed in claim 4, wherein the photo-resist layer is a positive photo-resist, the row and column conductors (30, 34) are not transparent to the irradiation used in the processing and the pixel electrodes (12) are transparent to the irradiation used in the processing.

6. A method as claimed in claim 5, wherein the processing comprises removing the exposed photo-resist to leave regions (70a, 70b) of photo-resist over the row and column electrode pattern.

7. A method as claimed in claim 4, wherein the photo-resist layer is a negative photo-resist, the row and column conductors are transparent to the irradiation used in the processing and the pixel electrodes are not transparent to the irradiation used in the processing.

8. A method as claimed in claim 7, wherein the processing comprises removing the non-exposed photo-resist to leave regions of photo-resist outside the pixel electrode pattern.

9. A method as claimed in claim 6, wherein the optical layer mixture is provided in the spaces between the remaining photo-resist regions.

10. A method as claimed in claim 9, wherein the optical layer mixture is also provided over the remaining photo-resist regions.

11. A method as claimed in claim 4, wherein display pixel cells are enclosed by photo-resist layer side walls, the active plate, and the polymer surface layer.

12. A method as claimed in claim 1, further comprising, after producing the active plate, providing the optical layer mixture of an electro-optical material and a polymer precursor over the active plate, and wherein the upper layer comprises the optical layer mixture (84).

13. A method as claimed in claim 12, wherein the row and column conductors (82) are transparent to the irradiation used in the processing and the pixel electrodes are opaque to the irradiation used in the processing, and the processing thereby forms polymerized side walls (86) over the row and column conductor pattern.

14. A method as claimed in claim 1, further comprising applying a liquid crystal alignment layer over the active plate.

15. A method as claimed in claim 14, wherein a photosensitive alignment layer is provided over the active plate, and wherein when irradiating through the substrate, regions of the photosensitive alignment layer are activated.

16. A method as claimed in claim 15, wherein the irradiating uses polarized UV light.

17. A method as claimed in claim 1, wherein the electro-optical material comprises a liquid crystal material.

18. An active matrix display device having an optical layer comprising a mixture of an electro-optical material and a polymer precursor, comprising:
an active plate comprising:
a substrate (60) carrying an array of pixel circuits, each having a pixel electrode (12);
a plurality of row conductors (30) associated with rows of pixels; and
a plurality of column conductors (34) associated with columns of pixels; and
an array of display pixels comprising electro-optical material enclosed between side walls, a polymerized surface layer (9;88) of the mixture and the active plate, and wherein the side walls are aligned over the row and column conductor pattern (30, 34).

19. A device as claimed in claim 18, wherein the side walls (86) are formed from polymerized regions of the mixture.

20. An active matrix display device having an optical layer comprising a mixture of an electro-optical material and a polymer precursor, comprising:
an active plate comprising:
a substrate (60) carrying an array of pixel circuits, each having a pixel electrode (12);
a plurality of row conductors (30) associated with rows of pixels; and
a plurality of column conductors (34) associated with columns of pixels; and
an array of display pixels comprising electro-optical material enclosed between side walls, a polymerized surface layer (9) of the mixture and the active plate, and wherein the side walls are aligned with the spaces between the pixel electrode pattern.

21. A device as claimed in claim 18, wherein the side walls are formed from photo-resist.

22. A device as claimed in claim 18, further comprising a liquid crystal alignment layer over the active plate.

23. A device as claimed in claim 18, wherein the electro-optical material comprises a liquid crystal material.
